(19) United States
(12) Patent Application Publication
(10) Pub. No.: US 2026/0250047 A1
(43) Pub. Date: Aug. 27, 2026

(54) WATER-RESISTANT COMPOSTABLE BAG

(71) Applicant: PAN PACIFIC PLASTICS MFG., INC., Hayward, CA (US)

(72) Inventor: Hin Siang Michael TAN, Danville, CA (US)

(21) Appl. No.: 19/545,243

(22) Filed: Feb. 20, 2026

Related U.S. Application Data
(60) Provisional application No. 63/761,382, filed on Feb. 21, 2025.

(51) Int. Cl. B65D 30/08; B65D 30/10; B65D 65/46; B65D 85/50

(52) U.S. Cl. CPC B65D 31/02; B65D 31/16; B65D 65/466; B65D 85/505

(57) ABSTRACT

A water-resistant, fully compostable bag for holding moisture-containing or liquid contents. The bag is formed from two sheets of compostable material, such as kraft paper coated with a water-resistant coating, that are heat sealed together. The coating can be a biodegradable polylactic acid or polyhydroxyalkanoate coating. The seal can be reinforced by providing multiple parallel seals. The water-resistant compostable bag is capable of holding liquids for at least three hours and up to eight hours or more.

### RELATED APPLICATION

This application claims priority under 35 U.S.C. §119(e) from co-pending U.S. Provisional Patent Application No. 63/761,382 (Attorney Docket No. MTANP013P), filed Feb. 21, 2025, which is entitled "MULTI-LAYER COMPOSTABLE BAG", which is hereby incorporated by reference herein in its entirety.

### FIELD OF THE INVENTION

The present invention relates to bags, and more particularly, relates to fully compostable water-resistant bags that can be used in the floral and grocery industries.

### BACKGROUND OF THE INVENTION

Conventional paper and plastic bags have been widely used in the retail and food industries for many decades. These upper open ended paper bags are easy to open and fill with contents. Some of these bags have handles while others do not.

Paper bags do not perform well and are not reliable for contents that have moisture or grease, which can leak out of and also weaken the paper bag. For such contents, plastic bags have reliably been used for many decades. However, there has been an increasing desire for more sustainable products and reducing plastic waste as well as legislation for prohibiting the use of plastic bags. With increased legislation prohibiting plastic bags and legislation requiring stores, such as grocery stores, to provide compostable bags, there is a need for cost-efficient, reliable, compostable water-resistant bags.

Accordingly, it is desirable to provide a water-resistant, compostable bag that is capable of reliably transporting and holding contents that may have moisture, such as freshly cut flowers.

### SUMMARY OF THE INVENTION

In accordance with an embodiment, a water-resistant compostable bag is provided. The water-resistant compostable bag includes a compostable first sheet-like panel, a compostable second-sheet-like panel, and a water-resistant seal. The compostable first sheet-like panel has an interior surface and an exterior surface, and has an upper edge, a bottom edge, and two side edges. A compostable water-resistant coating is disposed on the interior surface. The compostable second sheet-like panel has an interior surface and an exterior surface. The interior surface of the first sheet-like panel faces the interior surface of the second sheet-like panel. The second sheet-like panel also has an upper edge, a bottom edge, and two side edges, and a compostable water-resistant coating is disposed on the interior surface. The water-resistant seal joins each of the bottom and side edges of the first sheet-like panel to respective bottom and side edges of the second sheet-like panel. The respective interior surfaces of the first and second sheet-like panels collectively define a content-receiving region of the compostable bag configured to hold liquid contents without leakage for at least three hours.

In accordance with another embodiment, a water-resistant compostable bag is provided. The water-resistant compostable bag includes a first sheet-like panel and a second sheet-like panel. The first sheet-like panel having a top edge, a bottom edge, and two side edges. The second sheet-like panel has a same size and shape as the first panel. The second sheet-like panel is sealed to the first sheet-like panel along the bottom edge and two side edges. Each of the first and second panels includes a first layer comprising a first compostable material and a second layer over the first layer. The second layer comprises a second compostable material, and the second compostable material is different from the first compostable material. Respective second layers of the first and second sheet-like panels collectively define a content-receiving region of the compostable bag configured to hold liquid contents without leakage for at least three hours.

In accordance with yet another embodiment, a water-resistant compostable bag is provided. The water-resistant bag includes a compostable first-sheet like panel, a compostable second sheet-like panel, and a water-resistant seal. The compostable first sheet-like panel has an interior surface and an exterior surface. The first sheet-like panel has an upper edge and a sealed edge. The compostable water-resistant coating is disposed on the interior surface of the first-sheet-like panel. The compostable second sheet-like panel has an interior surface and an exterior surface. The interior surface of the first sheet-like panel faces the interior surface of the second sheet-like panel, and the second sheet-like panel has an upper edge and a sealed edge. A compostable water-resistant coating is disposed on the interior surface of the second sheet-like panel. The water-resistant seal joins the sealed edge of the first sheet-like panel to a respective sealed edge of the second sheet-like panel. The upper edges of the first and second sheet-like panels are not joined to one another and are not sealable. Respective interior surfaces of the first and second sheet-like panels collectively define a content-receiving region of the compostable bag configured to hold liquid contents without leakage for at least three hours.

### BRIEF DESCRIPTION OF THE DRAWINGS

The assembly of the present invention has other objects and features of advantage which will be more readily apparent from the following description of the best mode of carrying out the invention and the appended claims, when taken in conjunction with the accompanying drawings, in which:

FIG. 1A is a front view of an embodiment of a water-resistant compostable bag in a closed, flat state.

FIG. 1B is a side perspective view of the embodiment shown in FIG. 1A in an open state receiving a bouquet of flowers with wet stems and a small amount of water.

FIG. 1C is a front perspective view of the embodiment shown in FIGS. 1A and 1B in an open state.

FIG. 2A is a front view of a water-resistant compostable bag according to another embodiment.

FIG. 2B is a rear view of the embodiment shown in FIG. 2A.

FIG. 3 shows different configurations for a water-resistant compostable bag.

FIG. 4 shows an embodiment of the water-resistant compostable bag having two rectangular sheet-like panels formed by a continuous sheet.

FIG. 5A is a front view of an embodiment of a water-resistant compostable bag.

FIG. 5B is a rear view of the embodiment shown in FIG. 5A.

### DETAILED DESCRIPTION OF THE INVENTION

While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims. It will be noted here that for a better understanding, like components are designated by like reference numerals throughout the various figures.

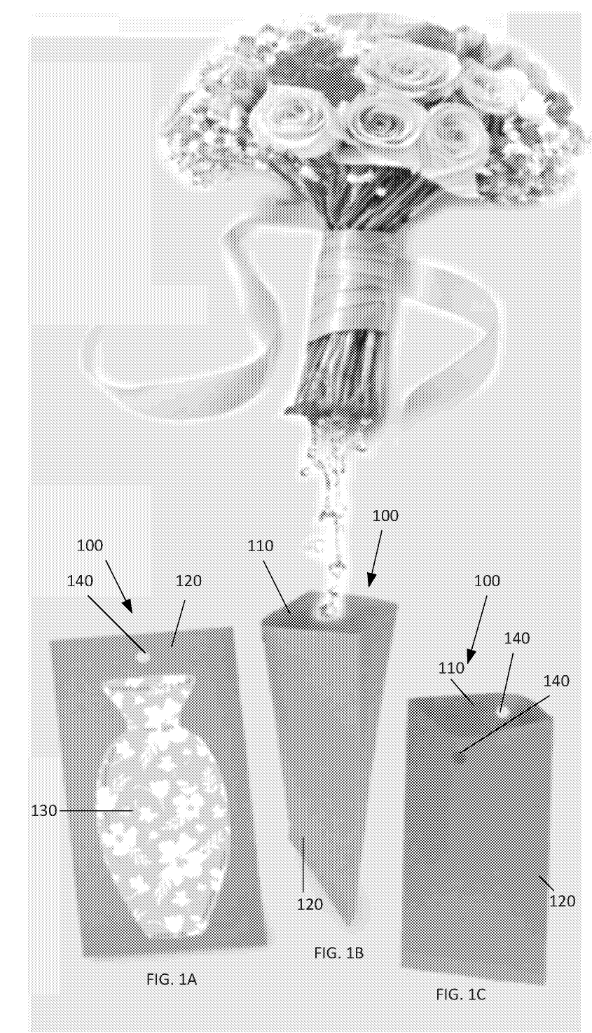

With reference to FIGS. 1A-5B, embodiments of a water-resistant compostable bag 100 are described. According to an embodiment, the water-resistant compostable bag 100 has a water-resistant compostable interior coating 110 for water resistance. The bag 100 also has a compostable outer layer 120. In an embodiment, the outer layer 120 is certified polylactic acid (PLA) coated recycled kraft paper that meets ASTM D6400 standard specifications. The bag 100, with its compostable interior coating 110 and compostable outer layer 120, is not only fully compostable but also a leak-proof alternative to plastic bags, designed for durability and functionality while maintaining environmental integrity.

PLA is a bioplastic that is made from renewable plant-based materials, such as corn, cassava, and sugarcane. A PLA coating can be applied to the interior of a paper bag to provide a water-resistant compostable coating for leak prevention. According to some embodiments, a PLA coating 110 is sprayed onto a surface of the compostable outer layer 120. In other embodiments, a PLA film is applied to a surface of the compostable outer layer to form a compostable, water-resistant coating 110.

The thickness of the water-resistant compostable coating 110 can be adjusted for different embodiments. For example, in an embodiment where a machine for making the compostable bag 100 is designed for a total paper weight and coating of 68 gsm -120 gsm, a 23 gsm coating 100 can be applied to 48 gsm paper 120 for a total of 68 gsm. It will be understood that the paper and coating thickness can be adjusted as desired. The water-resistant compostable coating 110 should be at least 9 gsm. According to another embodiment, the water-resistant compostable coating 110 is at least 10 gsm. In still another embodiment, the water-resistant compostable coating is at least 20 gsm. It will be understood that the thicker the coating 110, the more water-resistance it will provide.

In other embodiments, the compostable water-resistant coating 110 is a polyhydroxyalkanoate (PHA) coating. PHA is a biodegradable and compostable material formed by microbial fermentation, and is also food safe and water-resistant. PHA coatings are typically applied by spray coating or extrusion coating. It will be understood that, in other embodiments, the coating 110 can formed from any suitable water-resistant compostable material.

According to an embodiment, the compostable outer layer 120 is kraft paper with at least 40% recycled content. According to an alternative embodiment, the compostable outer layer 120 is kraft paper with at least 50% recycled content. In other embodiments, the compostable outer layer 120 can have varying amounts of recycled content.

Embodiments of the water-resistant compostable bag 100 provide a sustainable, leak-proof solution for floral packaging, and are especially suitable for use in floral departments of grocery stores. Cut flowers are typically displayed in buckets of water in grocery stores and roadside floral stands. Use of the compostable bag 100 for packaging cut flowers prevents water from dripping off flower stems onto floors or counters and creating dangerous, slippery situations, thereby limiting liability for the stores. As noted above, the bags 100 are fully compostable and durable, and are an environmentally friendly, leak-proof alternative to plastic or cellophane floral bouquet bags.

An embodiment of a water-resistant compostable bag 100 for holding cut flowers is shown in FIGS. 1A-1C. Such bags are sometimes known as bouquet bags or bouquet sleeves. The embodiments shown in FIGS. 1A-1C have a sealed bottom. Other embodiments may have an open bottom such that the cut ends of flowers may extend past the end of the bag. Unlike conventional bouquet sleeves made of cellophane, polypropylene, or other plastics, the water-resistant compostable bag 100 described herein designed for holding cut flowers is fully compostable.

FIG. 1A shows the bag 100 in its closed, flat state. FIGS. 1B and 1C show the bag in its open state, with FIG. 1B shown receiving a bouquet of flowers with wet stems and a small amount of water. In the illustrated embodiment shown in FIGS. 1A-1C, the compostable bag 100 has a generally rectangular shape and a paper outer layer 120, which is compostable. The inner surface of the outer layer 120 is coated with a water-resistant compostable coating 110 for water resistance. The compostable bag 100 is capable of containing room temperature liquid, such as water, with no leakage for at least three hours and as many as eight to ten hours. According to an embodiment, the compostable bag 100 is capable of containing room temperature water for at least four hours without any leakage. In some embodiments, the compostable bag 100 is capable of holding water for 24 hours or more without leakage. This embodiment comprises an outer paper layer 120 of kraft paper with an inner PLA coating 110 to provide a water-resistant lining. This embodiment meets ASTM D6400 standard specifications. The water-resistant compostable coating 110 ensures long-lasting leak prevention while maintaining environmental integrity. The compostable bag 100 is especially useful for holding cut flowers if the flowers are to be presented as a gift many hours later. Often, customers purchase flowers intended to be presented several hours later after an event, such as a graduation or performance. With the ability to contain water without leakage, the compostable bag 100 can hold the cut flowers with the cut ends of the stems in water for several hours so that the flowers remain fresh when they are presented. The water-resistant bag 100 also keeps groceries and other items in a shopping cart dry from wet flower stems.

As shown in FIG. 1A, in some embodiments, the paper outer layer 120 can be opaque and printed with a design 130 and/or information, such as branding and/or flower care instructions. A design printed on the bag can enhance the presentation. As shown in FIGS. 1A-1C, the water-resistant compostable bag 100 can also be provided with at least one hole 140 at the top so that the bags 100 can be hung in a grocery store on standard racks or on other suitable racks. In other embodiments, the bags 100 do not have any such holes.

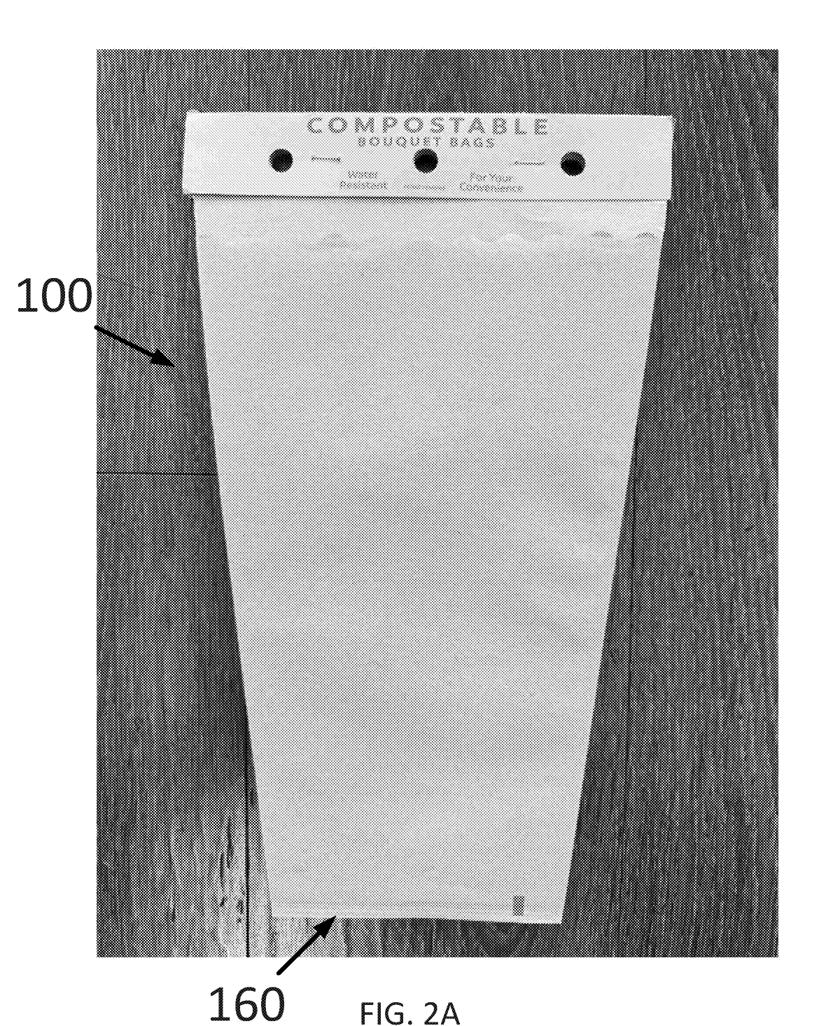

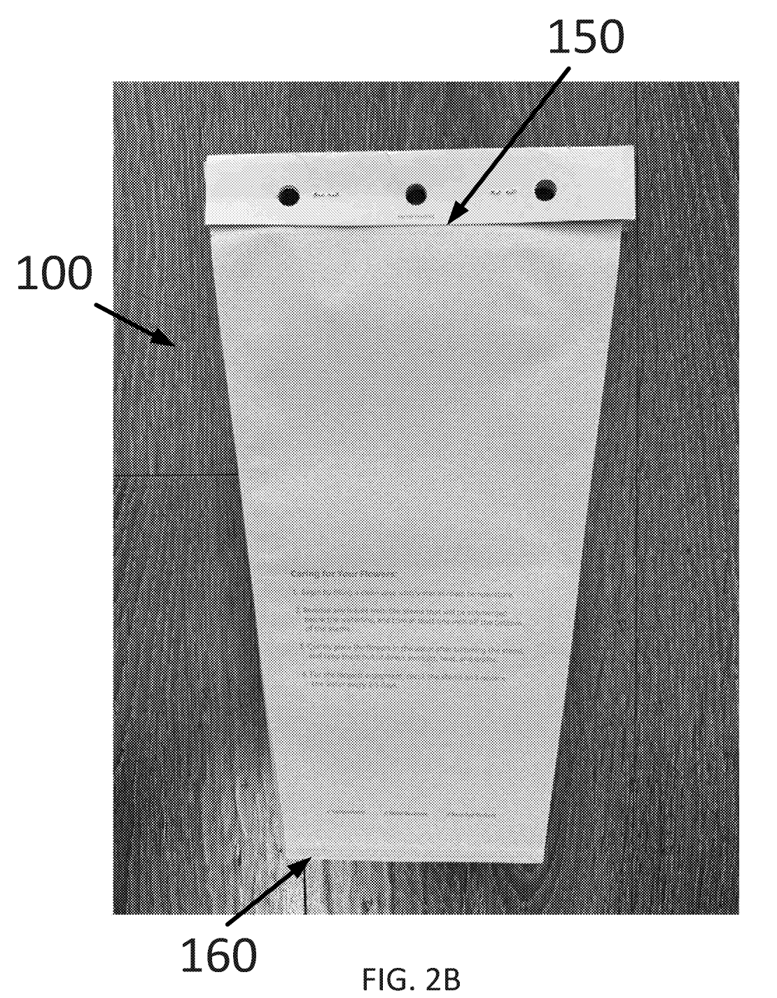

Another embodiment of the bag 100 is shown in FIGS. 2A-2B. In this embodiment, the bag 100 has a generally elongated trapezoidal shape with an upper edge 150 that is wider than the bottom edge 160. It will be understood that a bag 100 having such a tapered shape is suitable for holding a bouquet of flowers as stems are generally thin; the cut ends of stems are generally thin and flowers at the tops of stems are larger and have more volume. It will be understood that the embodiment illustrated in FIGS. 2A-2B does not have any holes for hanging on a rack but rather is shown attached to a header card having holes for hanging on a rack. In this embodiment, the bags 100 are attached to the header card via perforations at the upper edge 150 on the rear side of the bag 100. The perforations allow the bag 100 to be separated from the header card while the header card remains on the rack.

In addition, the water-resistant compostable bags 100 can also be used for restaurants and food delivery to securely transport liquid items, such as soups, sauces, and gravies. In grocery stores, the bags 100 can be used for frozen foods and wet produce to contain moisture from condensation or damp produce. The compostable bags 100 can also be used to contain liquid-based medication or as air-sick bags, such as those used on airplanes.

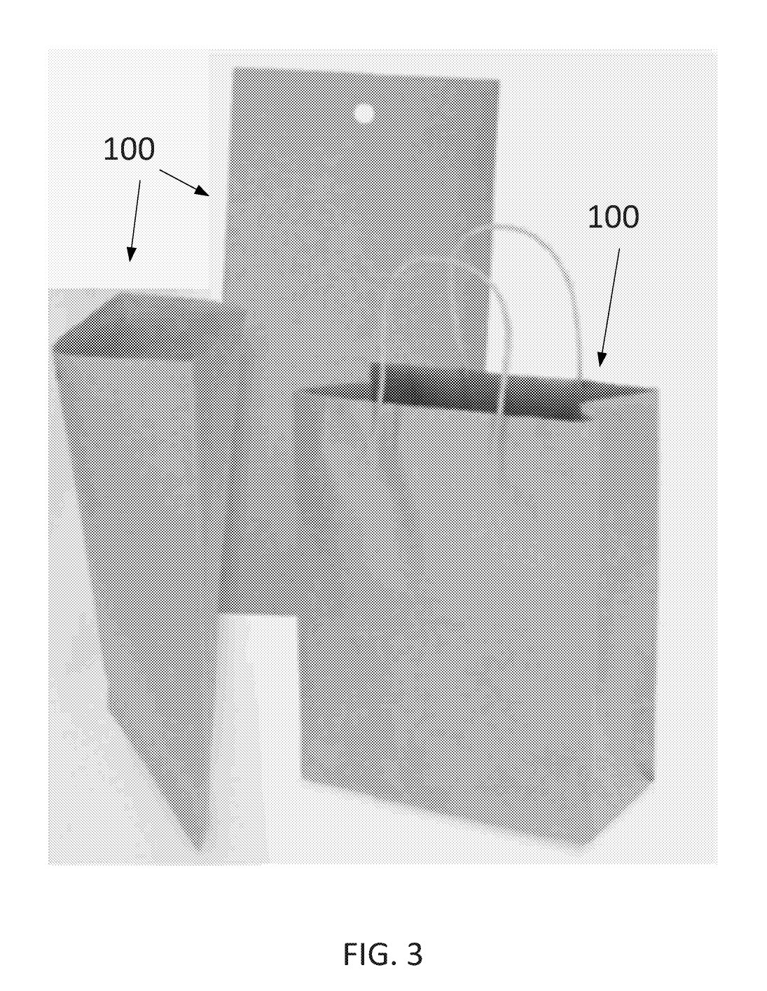

FIG. 3 shows different embodiments of the water-resistant compostable bag 100. The compostable bag 100 can be made in a variety of custom sizes and shapes. FIG. 3 shows some possible configurations for the bags 100. As shown in FIG. 3, the compostable bag 100 can be a flat bag and it can have different shapes, such as a square, rectangle, or triangle. The compostable bag 100 can be made with or without handles and with or without side gussets. In certain embodiments, the compostable bag may have a flat bottom.

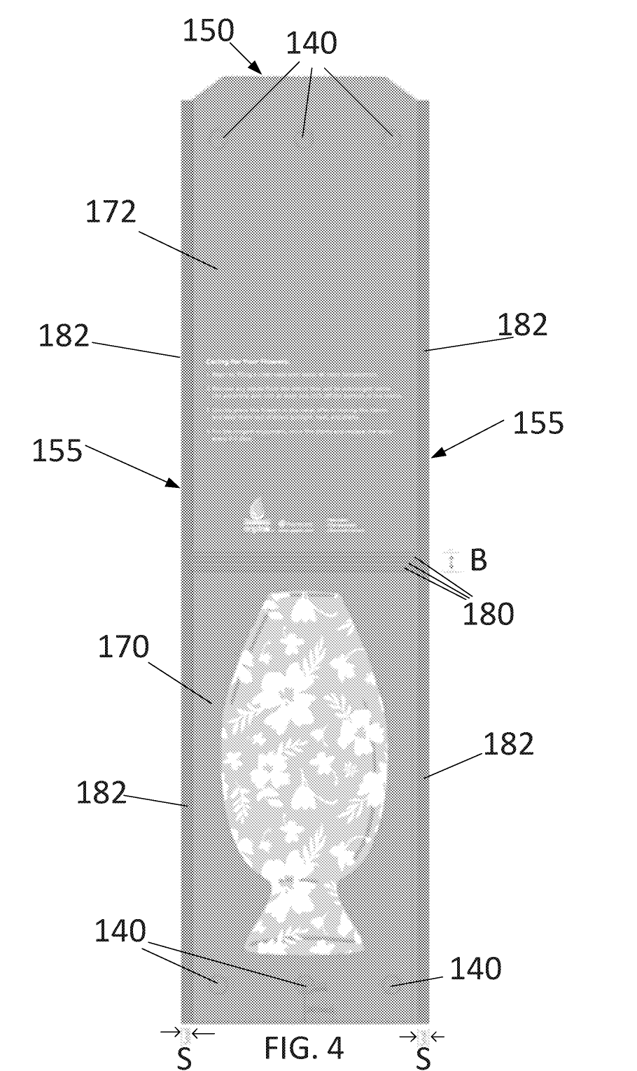

The compostable bag 100 includes two sheet-like panels 170, 172 sealed together to form a bag 100. FIG. 4 shows an embodiment of the compostable bag 100 having two rectangular sheet-like panels 170, 172. In the embodiment shown in FIG. 4, the two sheet-like panels 170, 172 are formed from one single sheet of material. It will be understood that, in other embodiments, the two sheet-like panels 170, 172 are separate sheets. Each of the sheet-like panels 170, 172 is formed from a compostable paper material 120 having a compostable water-resistant coating 110 on one side. The two sheet-like panels 170, 172 are stacked one on top of the other such that surfaces having the compostable water-resistant coating 110 face one another and form the inner surface of the bag 100. It will be understood that the compostable water-resistant coating 110 is not shown in FIG. 4 and that only the uncoated surface of the paper 120 is shown. In the embodiment shown in FIG. 4, the sheet is folded in half such that the surfaces having the water-resistant coating 110 face one another to form the interior surface of the bag 100.

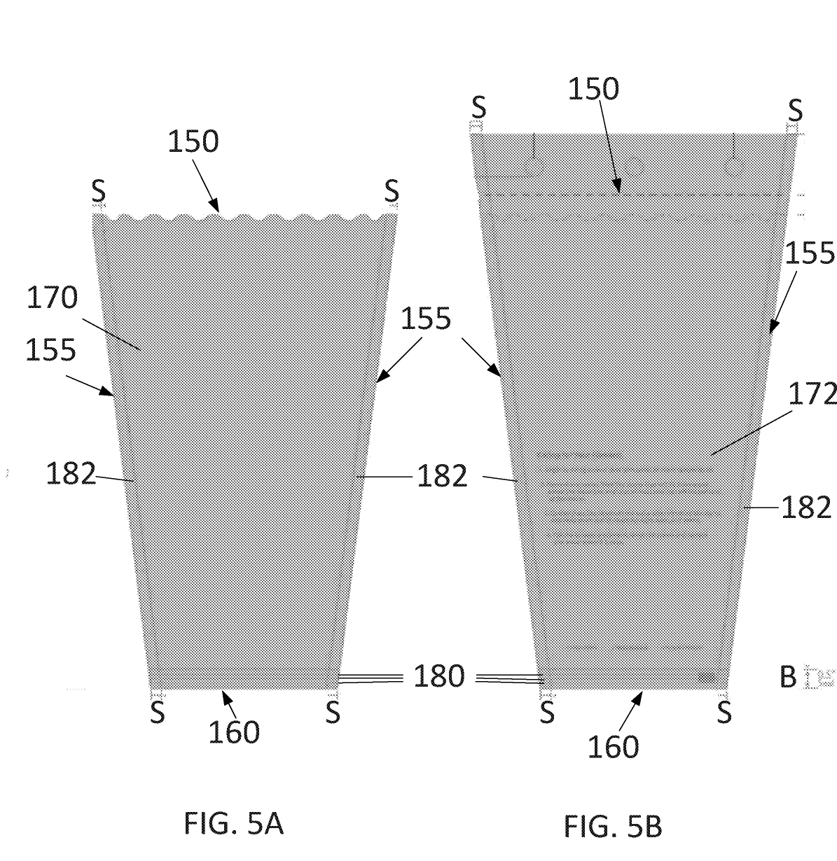

The two sheet-like panels 170, 172 are sealed to one another by side seals 182 and, in some embodiments, at least one bottom seal 180. As shown in the illustrated embodiments, the side seals 182 are formed along the side edges 155 of the sheet-like panels and the bottom seal 180 is formed along the bottom edge 160. According to some embodiments, the compostable bag 100 has a water-resistant bottom seal 180 and water-resistant side seals 182 to provide additional leak protection, as shown in FIGS. 4-5B.

The bottom seal 180 can be reinforced with additional seals 180 for extra strength and for maximum leak protection. As shown in FIGS. 4-5B, the bag 100 has three separate bottom seals 180 that are spaced apart from and parallel to one another. If liquid happens to leak through a first bottom seal 180, the middle bottom seal 180 should stop any liquid from leaking through the middle bottom seal 180. A third bottom seal180 can be provided for additional leak protection. The side seals 182 can also be reinforced with additional seals 182 in a similar manner. It will be understood that, in other embodiments, an additional reinforcing seal is not necessarily parallel to a seal 180, 182, but rather just spaced apart from the seal 180, 182.

In other embodiments, the bottom seal 180 is not reinforced. In still other embodiments, the bag 100 does not have a bottom seal and is instead simply one continuous material forming both sheet-like panels 170, 172, where the material is folded in half to form the two sheet-like panels 170, 172 (FIG. 4). In this embodiment, there is no need for a bottom seal, as the water-resistant material is continuous.

Each of the bottom seal 180 and side seals 182 has a width of at least 1 mm. In some embodiments the seals 180, 182 have a width S in the range of about 1-10 mm. In an embodiment, each of the seals 180, 182 has a width S about 5 - 7.5 mm and the bottom seals 180 span a total width B about 0.5 – 1.0 inch, with each seal 180 having a width of about 5 - 7.5 mm. It will be understood that the width B is the distance from the bottom seal 180 closest to the bottom edge 160 to the bottom seal 180 farthest from the bottom edge 160. According to another embodiment, each of the seals 180, 182 has a width S of about 5 mm. Each of the embodiments shown in FIG. 4 and 5A-5B has three separate bottom seals 180 that are parallel to one another for reinforced leakage protection. Each of the bottom seals 180 extends along the entire width of the bag 100, as shown in FIGS. 4 and 5A-5B.

It will be understood that other embodiments, the widths of the side seals 182 and bottom seal 180 can be greater or smaller, and that the widths of the side seals 182 can be different from the widths of the bottom seals 180.

In some embodiments, the side edges 155 and bottom edge 160 are heat sealed to form crimped side seals 182 and bottom seals 180. In other embodiments, the side seals 182 and bottom seals 180 are glue seals formed from glues, such as cyanoacrylate, acrylic cement, acrylic glue, hot melt glue, water-based glue seal, and two-part epoxy. It will be understood that the seals 180, 182 can be either flat or embossed.

In the embodiment shown in FIGS. 5A-5B, the upper edge 150 of one of the sheet-like panels 170 is scalloped while the upper edge 150 of the other sheet-like panel 172 is not scalloped but rather a straight line (along a perforation line between the sheet-like panel 172 and the header card. The scalloped upper edge 150 provides a decorative edge and is also functional in that the scalloped upper edge 150 allows the user to easily separate the sheet-like panels 170, 172 at the upper edges 150 to open the bag 100 to insert contents (e.g., stems of cut flowers) into the interior content receiving region of the bag 100.

As shown in the illustrated embodiments, only the side edges 155 and bottom edges 160 of the respective sheet-like panels 170, 172 are sealed to one another. The upper edges 150 are unsealed. According to some embodiments, the upper edges 150 of the sheet-like panels 170, 172 are not only not sealed to one another, they cannot be sealed to one another (there is no mechanism on the bag 100 for sealing the upper edges 150 to one another).

While the present invention has been described in connection with the preferred form of practicing it and modifications thereto, those of ordinary skill in the art will understand that many other modifications can be made thereto within the scope of the claims that follow. Accordingly, it is not intended that the scope of the invention in any way be limited by the above description, but instead be determined entirely by reference to the claims that follow.

What is claimed is:

1. A water-resistant compostable bag, comprising:
a compostable first sheet-like panel having an interior surface and an exterior surface,
the first sheet-like panel having an upper edge, a bottom edge, and two side edges, wherein a
compostable water-resistant coating is disposed on the interior surface of the first sheet-like
panel;
a compostable second sheet-like panel having an interior surface and an exterior
surface, wherein the interior surface of the first sheet-like panel faces the interior surface of the
second sheet-like panel, the second sheet-like panel having an upper edge, a bottom edge, and
two side edges, wherein a compostable water-resistant coating is disposed on the interior surface
of the second sheet-like panel; and
a water-resistant seal joining each of the bottom and side edges of the first sheet-like
panel to respective bottom and side edges of the second sheet-like panel, wherein respective
interior surfaces of the first and second sheet-like panels collectively define a content-receiving
region of the compostable bag configured to hold liquid contents without leakage for at least
three hours.

2. The water-resistant compostable bag of claim 1, wherein the compostable water-resistant
coating is a polylactic acid coating.

3. The water-resistant compostable bag of claim 1, the compostable water-resistant coating
is disposed on paper.

4. The water-resistant compostable bag of claim 3, wherein the paper contains at least 40%
recycled content.

5. The water-resistant compostable bag of claim 1, further comprising at least one
additional water-resistant seal that is separate from and parallel to the water-resistant seal joining
the bottom edge of the first panel to the bottom edge of the second sheet-like panel.

6. The water-resistant compostable bag of claim 1, wherein each of the first and second
sheet-like panels has an elongated trapezoidal shape, wherein the upper edges are wider than the
bottom edges.

7. The water-resistant compostable bag of claim 1, wherein at least one of the seals is a
heat seal.

8. The water-resistant compostable bag of claim 1, wherein at least one of the seals is a
glue seal.

9. A water-resistant compostable bag, comprising:
a first sheet-like panel having a top edge, a bottom edge, and two side edges; and
a second sheet-like panel having a same size and shape as the first panel and the second
sheet-like panel has a top edge, a bottom edge, and two side edges, wherein the second sheet-like
panel is sealed to the first sheet-like panel along respective bottom edges and side edges, and
wherein each of the first and second sheet-like panels comprises:
a first layer comprising a first compostable material; and
a second layer over the first layer, wherein the second layer comprises a second
compostable material, wherein the second compostable material is different from the first
compostable material; and
wherein the respective second layers of the first and second sheet-like panels collectively
define a content-receiving region of the compostable bag configured to hold liquid contents
without leakage for at least three hours.

10. The water-resistant compostable bag of claim 9, wherein the second compostable
material is a water-resistant compostable material.

11. The water-resistant compostable bag of claim 10, wherein the second compostable
material is polylactic acid.

12. The water-resistant compostable bag of claim 9, wherein the first compostable material
is paper.

13. The water-resistant compostable bag of claim 9, wherein each of the first and second
sheet-like panels has a rectangular shape.

14. The water-resistant compostable bag of claim 9, wherein each of the first and second
sheet-like panels has a trapezoidal shape.

15. The water-resistant compostable bag of claim 9, wherein the second sheet-like panel is
sealed to the first sheet-like panel by heat sealing.

16. The water-resistant compostable bag of claim 9, further comprising at least one
reinforcing additional seal sealing the first sheet-like panel to the second sheet-like panel, wherein
the at least one reinforcing additional seal is spaced apart from and a seal sealing respective bottom
edges of the first and second sheet-like panels.

17. A water-resistant compostable bag, comprising:
a compostable first sheet-like panel having an interior surface and an exterior
surface, the first sheet-like panel having an upper edge and a sealed edge, wherein a compostable
water-resistant coating is disposed on the interior surface of the first-sheet-like panel;
a compostable second sheet-like panel having an interior surface and an exterior
surface, wherein the interior surface of the first sheet-like panel faces the interior surface of the
second sheet-like panel, the second sheet-like panel having an upper edge and a sealed edge,
wherein a compostable water-resistant coating is disposed on the interior surface of the second
sheet-like panel; and
a water-resistant seal joining the sealed edge of the first sheet-like panel to a
respective sealed edge of the second sheet-like panel, wherein the upper edges of the first and
second sheet-like panels are not joined to one another and not sealable, and wherein respective
interior surfaces of the first and second sheet-like panels collectively define a content-receiving
region of the compostable bag configured to hold liquid contents without leakage for at least three
hours.

18. The water-resistant compostable bag of claim 17, wherein the sealed edge of each of the
first and second sheet-like panels comprises a bottom edge and two side edges.

19. The water-resistant compostable bag of claim 17, wherein the water-resistant seal is
formed by heat sealing.

20. The water-resistant compostable bag of claim 17, wherein the water-resistant coating is
polylactic acid.
